(19) United States
(12) Patent Application Publication
(10) Pub. No.: US 2007/0058286 A1
(43) Pub. Date: Mar. 15, 2007

(54) Media cartridge autoloader

(76) Inventor: Hiromi Tanaka, Tokyo (JP)

Correspondence Address: ANDERSON KILL & OLICK, P.C., 1251 Avenue of the Americas, New York, NY, 10020, US

(21) Appl. No.: 11/286,160

(22) Filed: Nov. 22, 2005

(30) Foreign Application Priority Data
Sep. 15, 2005 (JP) 2005-269194

(51) Int. Cl. G11B 15/68

(52) U.S. Cl. 360/92

(57) ABSTRACT

A media cartridge autoloader that transfers a media cartridge between a movable media cartridge container and a media drive is disclosed. The media cartridge autoloader includes a movable belt that is positioned around a pulley, the belt moving the media cartridge container; a coupling member that couples the media cartridge container to the belt; and an engaging mechanism that engages the coupling member when the media cartridge is positioned near the pulley.

### BACKGROUND OF THE INVENTION

1. Field of the Invention

The present invention relates to a media cartridge autoloader that is configured to transport plural media cartridge containers having media cartridges inserted therein to enable an arbitrary media cartridge to be taken out.

2. Description of the Related Art

A typical media cartridge autoloader includes a media cartridge picker in the center, a mail slot at the front side, a read/write media drive at the rear side, and media cartridge transport magazines disposed one at each lateral side.

The media cartridge picker is configured to transport a media cartridge between the mail slot, the media drive, and the media cartridge transport magazines.

The media cartridge transport magazines each comprises plural media cartridge storage cases along a loop belt so as to store the media cartridges therein. The loop belt is driven such that a selected one of the media cartridge storage cases is moved next to the media cartridge picker.

To store many media cartridges, the media cartridge transport magazines can be provided one at each side. Also, there are plural types of media cartridges with differing shapes and sizes depending on the recording method, and in turn, plural types of media cartridge transport magazines are provided so that a suitable type of media cartridge transport magazine may be selected as well as the preferred recording method according to a user request.

The media cartridge transport magazine includes plural media cartridge containers having media cartridges inserted therein. Upon loading a designated media cartridge into the read/write media drive, the belt is driven to transport the media cartridge container so that the designated media cartridge may be taken out.

In the media cartridge autoloader having a structure as is described above, the media cartridge containers are transported through driving a belt that is wound over a pair of pulleys. In such an arrangement, when a media cartridge container is raised/lowered upon being transported past one of the pulleys, a load may be generated that induces separation of the belt from the pulleys. Accordingly, measures for stably supporting the media cartridges are demanded.

### SUMMARY OF THE INVENTION

The present invention provides a media cartridge autoloader that is capable of resolving one or more of the problems described above.

According to an aspect of the present invention, a media cartridge autoloader that transfers a media cartridge between a movable media cartridge container and a media drive is provided, the media cartridge autoloader including:

a movable belt that is positioned around a pulley, the belt moving the media cartridge container;

a coupling member that couples the media cartridge container to the belt; and

an engaging mechanism that engages the coupling member when the media cartridge is positioned near the pulley.

According to a preferred embodiment, the engaging mechanism is integrally formed as part of the pulley. Further, the engaging mechanism may be radially recessed as part of the pulley.

In another preferred embodiment, the coupling member is configured to move along a periphery of the pulley and includes a protruding part that engages with the engaging mechanism when the coupling part moves along the periphery of the pulley.

In another preferred embodiment, the coupling member supports a load of the media cartridge container with the engagement between the protruding part and the engaging mechanism while the media cartridge container is raised/lowered through rotation of the pulley.

In another preferred embodiment, the belt is positioned around two pulleys, each pulley including an engaging mechanism that engages the coupling member when the media cartridge is positioned near the pulley.

In another preferred embodiment, the belt rotates around the pulleys in a substantially oval configuration.

In another preferred embodiment, the movable belt simultaneously moves a plurality of media cartridge containers.

In another preferred embodiment, each of the media cartridge containers is coupled to the belt by a separate coupling member.

In another preferred embodiment, the pulley includes two substantially similar engaging mechanisms.

In another preferred embodiment, the two engaging mechanisms are positioned at approximately 180 degrees from one another around a periphery of the pulley.

According to another aspect of the present invention, a method of transferring a media cartridge between a movable media cartridge container and a media drive is provided, the method including the steps of:

moving the media cartridge container by a movable belt that is positioned around a pulley, the media cartridge being coupled to the belt by a coupling member; and

engaging the coupling member with an engaging mechanism when the media cartridge is positioned near the pulley.

According to an aspect of the present invention, an engaging mechanism engages a coupling member that is coupled to a belt while a media cartridge container is positioned near the pulley so that the media cartridge container may be transported in a stable state without wobbling even when the media cartridge container is raised/lowered with the load of the media cartridge container acting on the belt, and the transporting speed of a media cartridge autoloader may be increased, for example.

### BRIEF DESCRIPTION OF THE DRAWINGS

FIG. 1 is a perspective view illustrating a media cartridge autoloader with an upper cover thereof removed according to a first embodiment of the present invention;

FIG. 2 is a side view illustrating the media cartridge autoloader of FIG. 1 with a side cover thereof removed;

FIG. 3 is a schematic illustration showing operations of a media cartridge picker;

FIG. 4 is a perspective view illustrating a main module;

FIG. 5 is an exploded view illustrating the main module;

FIG. 6 is a perspective view of the main module, viewed from a Y1 side;

FIG. 7 is a perspective view illustrating the media cartridge picker;

FIG. 8 is a perspective view illustrating the media cartridge picker with a pillar and a turntable removed;

FIG. 9 is an exploded perspective view illustrating the media cartridge picker;

FIG. 10 is an exploded perspective view illustrating a turntable lifting mechanism in detail;

FIG. 11 is a perspective view illustrating the turntable;

FIG. 12 is a schematic illustration showing a media cartridge transport mechanism;

FIG. 13 is a perspective view of the main module with the cartridge picker, a mail slot module, and a motor module removed, viewed from a Y2 side;

FIG. 14 is a perspective view of the main module of FIG. 13, viewed from the Y1 side;

FIG. 15 is a perspective view of a Y2-side part of the main module with the mail slot module removed, viewed obliquely from an X2 side;

FIG. 16 is a perspective view illustrating a magazine drive with a drive shaft unit located at a home position;

FIG. 17 is a perspective view showing an X1-side portion of the Y2-side part of the main module with the mail slot module removed;

FIG. 18 is a perspective view of the Y2-side part of the main module, viewed obliquely from an X1 side;

FIG. 19 is an enlarged perspective view showing a drive gear and a positioning pin disposed at the X2 side;

FIG. 20 shows a photo sensor for detecting the rotation angle of the turntable;

FIG. 21 is a perspective view of the media cartridge transport magazine with an X2-side lateral plate removed, viewed from the X2 side;

FIG. 22 is a perspective view of the media cartridge transport magazine of FIG. 21, viewed from the X1 side;

FIG. 23 is an enlarged view illustrating a part of the media cartridge transport magazine of FIG. 22;

FIG. 24A illustrates the media cartridge transport magazine drive in its initial state;

FIG. 24B illustrates the media cartridge transport magazine drive in a state to drive an X2-side magazine;

FIG. 24C illustrates the media cartridge transport magazine drive in a state to drive an X1-side magazine;

FIG. 25 illustrates an X2-side part of the drive shaft unit opposing a magazine in the initial state;

FIG. 26 illustrates the X2-side part of the drive shaft unit in a process of being coupled with the magazine;

FIG. 27 illustrates the X2-side part of the drive shaft unit coupled with the magazine;

FIG. 28 illustrates operations for correcting a center distance between the drive gear and the magazine gear;

FIGS. 29A-29D illustrate operations to be performed when tooth sections of the drive gear contact and interfere with tooth sections of the magazine gear;

FIG. 30 is a flowchart illustrating operations of a microcomputer of a motor control circuit;

FIGS. 31A-31C are diagrams illustrating a media cartridge container, FIG. 31A corresponding to a plan view, FIG. 31B corresponding to a front view, and FIG. 31C corresponding to a side view of the media cartridge container;

FIG. 32 is a perspective view of a container transport mechanism;

FIG. 33 is a perspective view of a container guide mechanism;

FIG. 34 is a diagram illustrating a state in which media cartridge containers 401 are coupled to a timing belt via belt coupling members;

FIGS. 35A and 35B are enlarged diagrams of an attaching structure of the belt coupling member, FIG. 35A corresponding to a front view, and FIG. 35B corresponding to a side view of the attaching structure;

FIG. 36 is a diagram illustrating an operation state before the belt coupling member is engaged with a pulley;

FIG. 37 is a diagram illustrating an engaged state between the pulley and the belt coupling member;

FIG. 38 is a diagram illustrating a state in which the belt coupling member and the pulley are rotated by 90 degrees in an engaged state; and

FIG. 39 is an enlarged view illustrating the direction of the load of the media cartridge container when the belt coupling member is in a horizontal state.

### DETAILED DESCRIPTION OF THE PREFERRED EMBODIMENT

In the following, preferred embodiments of the present invention are described with reference to the accompanying drawings.

### First Embodiment

The description of a first embodiment includes the following:

1. Configuration and Operations Overview of Tape cartridge autoloader 100

2. Configuration of Main Module 110

3. Configuration and Operations of Tape cartridge picker 102

4. Configuration of Media Cartridge Transport Magazine Drive 300
4-1. Configuration of Drive Shaft Unit 301
4-2. Configuration of Drive Shaft Unit Shift Mechanism 320
4-3. Configuration of Magazine Drive Motor Module 330

5. Configuration of Media Cartridge Transport Magazines 103, 104

6. Operations for Selectively Driving Media Cartridge Transport Magazines 103, 104

7. Operations of Microcomputer of Motor Control Circuit 410

8. Transport Mechanism for Media Cartridge Container 401

1 [Configuration and Operations Overview of Tape Cartridge Autoloader 100]

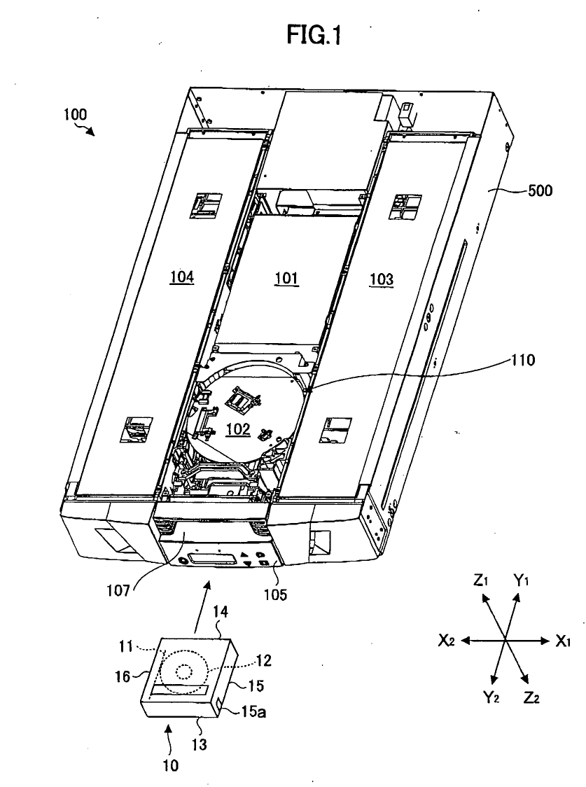

FIG. 1 is a perspective view illustrating a media cartridge autoloader 100 with an upper cover thereof removed according to the first embodiment of the present invention. In the embodiments illustrated in the figures, the media cartridge autoloader is used with one or more tape cartridges, and is therefore referred to as a tape cartridge autoloader. It is recognized, however, that although the following description and the figures provided herein pertain particularly to an autoloader used for tape cartridges, any other suitable type of media cartridge can equally be used with the present invention, such as an optical disk cartridge, as one non-exclusive example. The embodiments disclosed herein are not intended to limit the scope of the present invention in any manner to use with tape cartridges or any other single particular type of media. In other words, it is understood that the term “tape” as used herein can equally be substituted for the term “media”.

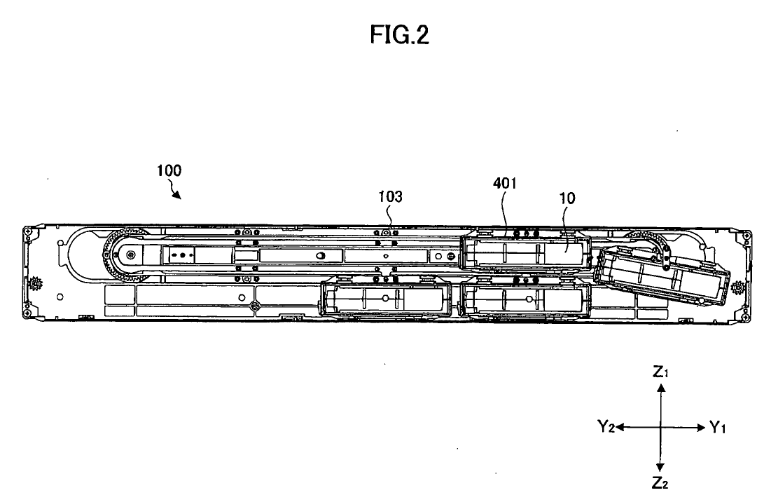

FIG. 2 is a side view illustrating the tape cartridge autoloader 100 with a side cover thereof removed. Throughout the drawings, the width direction is indicated by a line X1-X2, the depth direction is indicated by a line Y1-Y2, and the height direction is indicated by a line Z1-Z2.

In one embodiment, the tape cartridge autoloader 100 generally comprises a metal frame 500, a control panel 105 and a mail slot 107 both on a front panel, a main module 110 including a tape cartridge picker 102 at a position opposing the mail slot 107, a tape drive 101 disposed at the Y1 side of the main module 110, and one or more tape cartridge transport magazines 103 and 104 (for example, two tape cartridge transport magazines 103 and 104 are shown in the embodiment illustrated in FIG. 1), which in this embodiment, are disposed one at the X1 side and the X2 side of the main module 110. For example, the tape cartridge transport magazines 103 and 104 can be inserted toward the Y1 side from the front panel side and removably attached on opposing sides of the frame 500. In an alternative embodiment, the tape cartridge transport magazines 103, 104 can be positioned to have a different orientation relative to one another and/or to the main module 110. In one non-exclusive alternative embodiment, for example, although the tape cartridge transport magazines 103, 104 are shown to be generally parallel to one another in FIG. 1, they can be positioned in a substantially non-parallel orientation. It is understood that as used herein, either tape cartridge transport magazine 103, 104 can be the first tape cartridge transport magazine or the second tape cartridge transport magazine. Further, the tape cartridge autoloader 100 can be mounted in a rack by, for example, fixing four corners of the frame 500 to poles of the rack.

In certain embodiments, the tape cartridge autoloader 100 is designed such that such that operations of the tape cartridge picker 102 and operations of the tape cartridge transport magazines 103 and 104 do not overlap in terms of time.

A media cartridge 10 is used in the tape cartridge autoloader 100. Referring to FIG. 1, the media cartridge 10 includes a magnetic media 11 wound on a single reel 12 therein such that the magnetic media 11 is pulled out from a rear face of the media cartridge 10. The media cartridge 10 includes a front face 13, a rear face 14, side faces 15 and 16, and a notch 15a formed on the side face 15 which a cartridge pin (described below) engages.

The tape cartridge transport magazines 103 and 104 are each configured to store plural media cartridges 10 orienting the front faces 13 to face the tape cartridge picker 102. The tape cartridge transport magazines 103 and 104 are also configured to transport the media cartridges 10 along a racetrack path elongated in the Y1-Y2 direction, as illustrated in FIG. 2.

The tape drive 101 is operable to read and/or write data from or to the magnetic tape 11 pulled out from the loaded tape cartridge 10. The tape drive 101 includes a tape cartridge eject mechanism (not shown). Plural types of tape drives with different heights are available so that one drive is selected from them and attached to the tape cartridge autoloader 100. For this operation, the tape cartridge picker 102 is provided with a turntable lifting mechanism 150 (described below).

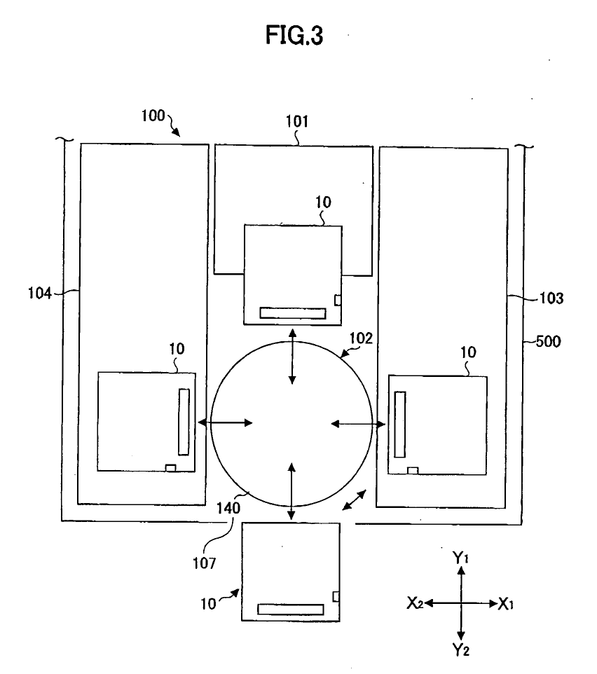

Referring to FIG. 3, the tape cartridge picker 102 is configured to transport the tape cartridge 10 onto or off of a turntable 140 for operations such as loading the tape cartridge 10 inserted through the mail slot 107 into the tape drive 101, retrieving the tape cartridge 10 from the tape cartridge transport magazines 103 and 104 to load the tape cartridge 10 onto the tape drive 101, retrieving the tape cartridge from the tape drive 101 to return the tape cartridge 10 to the tape cartridge transport magazines 103 and 104, and ejecting the tape cartridge 10 through the mail slot 107. The tape cartridge picker 102 is also configured to rotate the turntable 140 by a predetermined rotational interval, such as by approximately 90-degree increments, although the rotational interval can vary depending upon the design requirements of the autoloader 100. The tape cartridge picker 102 can also lift/lower the turntable 140 as necessary. When the turntable 140 is rotated, the orientation of the tape cartridge 10 is changed.

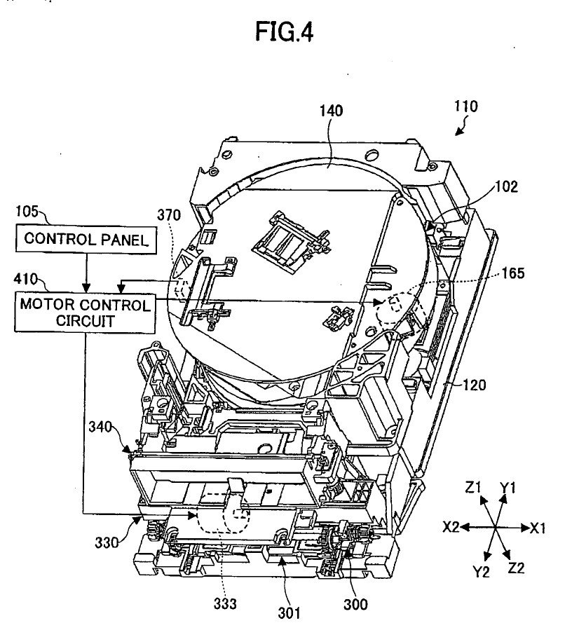

2 [Configuration of Main Module 110] (FIGS. 4-6)

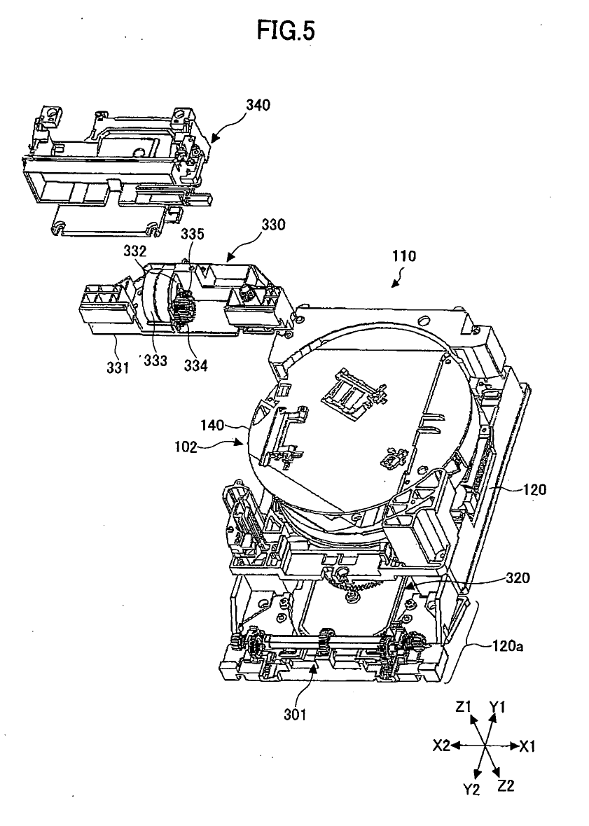

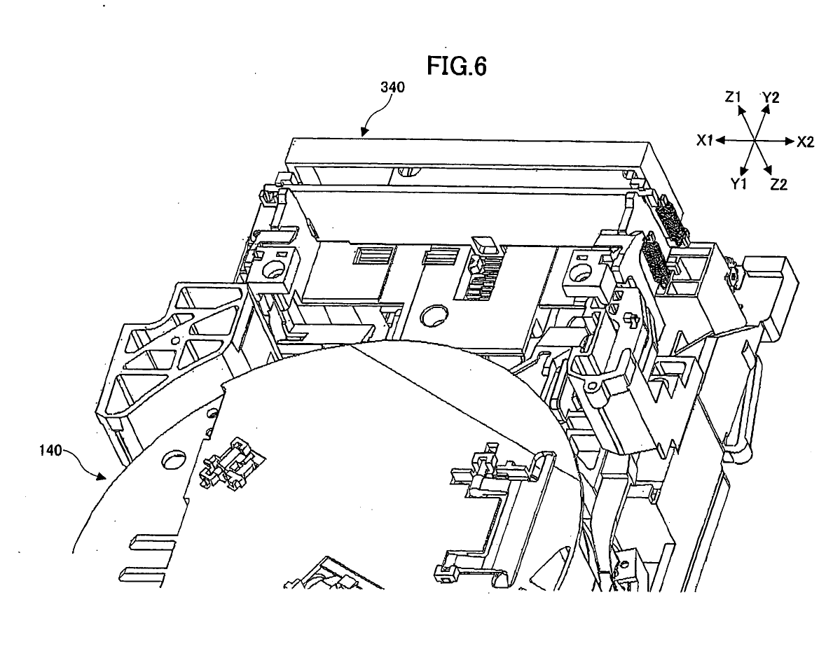

FIG. 4 is a perspective view of the main module 110. FIG. 5 is an exploded view of the main module 110. FIG. 6 is a perspective view of the main module 110, viewed from the Y1 side.

In this embodiment, the main module 110 includes a base 120. The main module 110 also includes the tape cartridge picker 102 and a tape cartridge transport magazine drive 300. The tape cartridge picker 102 can occupy a large part of the base 120. The base 120 includes an extension 120a extending at the Y2 side of the tape cartridge picker 102. A drive shaft unit 301 and a tape cartridge transport magazine drive motor module 330 are disposed on the extension 120a. For example, the mail slot module 340 can be mounted on the upper side of the magazine drive motor module 330. The magazine drive 300 comprises the drive shaft unit 301 and the magazine drive motor module 330 as described below.

A motor control circuit 410 shown in FIG. 4 drives, in response to a command generated when a user operates the control panel 105, a stepping motor 165 and a magazine drive motor 333 in a manner described below while monitoring signals from a photo sensor 370.

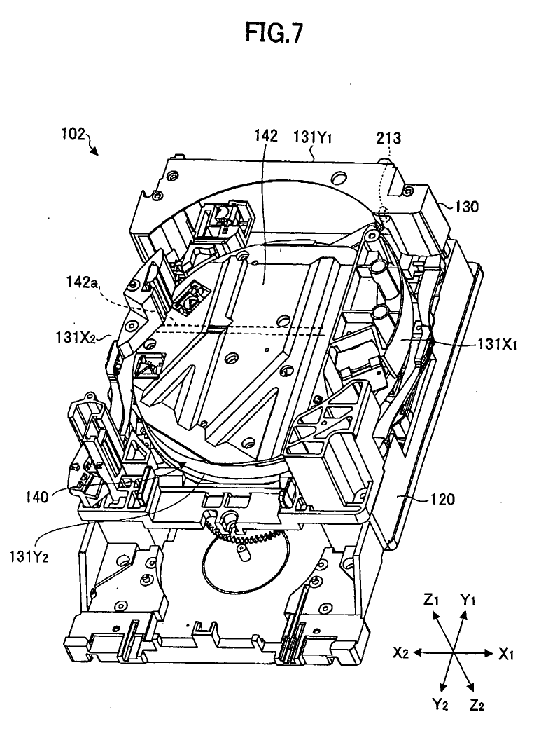

3 [Configuration and Operations of Tape Cartridge Picker 102] (FIGS. 7-12)

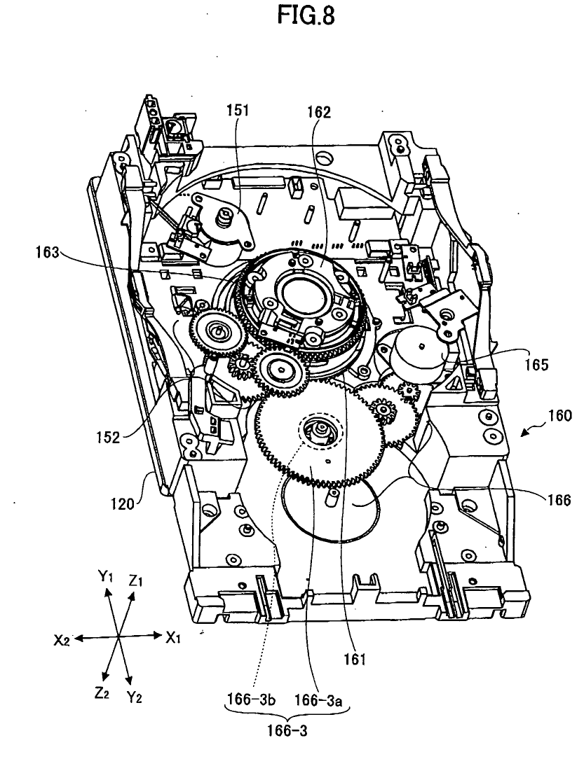

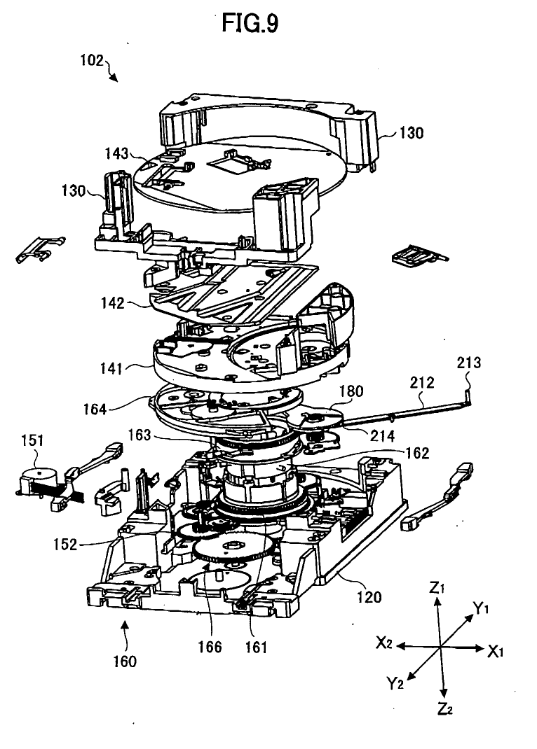

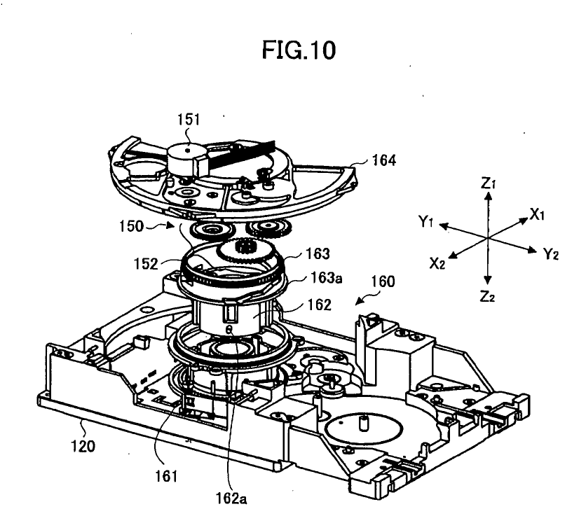

FIG. 7 illustrates the tape cartridge picker 102 with an upper plate 143 of the turntable 140 removed. FIG. 8 illustrates the tape cartridge picker 102 with a pillar 130 and the turntable 140 removed. FIG. 9 is an exploded perspective view illustrating the tape cartridge picker 102. FIG. 10 illustrates the turntable lifting mechanism 150 in detail.

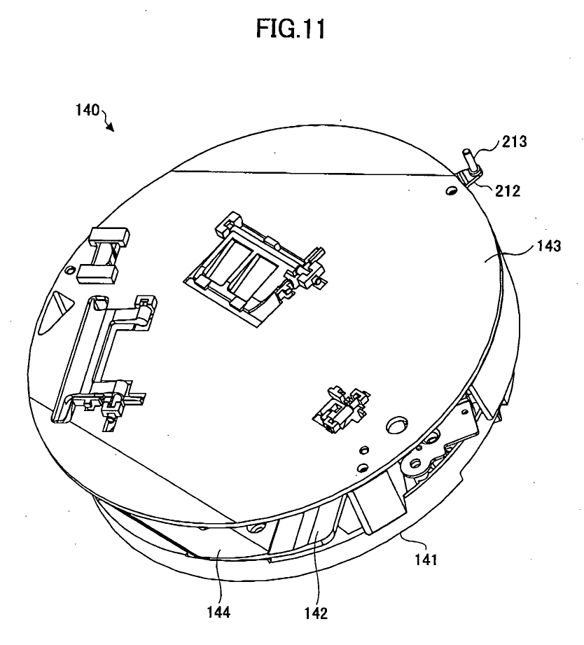

The tape cartridge picker 102 includes the pillar 130 mounted on the base 120, the turntable 140 (FIG. 11) configured to support the tape cartridge 10, the turntable lifting mechanism 150 (FIG. 10) configured to slightly lift and lower the turntable 140 for height position adjustment, and a turntable rotating mechanism 160 configured to rotate the turntable 140 by a predetermined rotational increment, such as in approximately 90 degree rotational increments, for example. The tape cartridge picker 102 has ports 131X1, 131X2, 131Y1, and 131Y2 on four sides thereof (see FIG. 7).

A rotating ring gear 161, a cylindrical stand 162, a lifting ring gear 163, and a sub base 164 are disposed on the base 120. The rotating ring gear 161 is rotatably attached to the base 120. The cylindrical stand 162 is arranged at the inner side of the rotating ring gear 161 and the lifting ring gear 163 so as to be rotated along with the rotating ring gear 161 and be lifted independently from the rotating ring gear 161. The lifting ring gear 163 is arranged at the upper side of the rotating ring gear 161 so as to be rotated independently from the rotating ring gear 161. A boss 162a (FIG. 10) of the cylindrical stand 162 is configured to engage a diagonal groove 163a of the lifting ring gear 163. The cylindrical stand 162 is rotated by rotation of the rotating ring gear 161, and lifted/lowered by rotation of the lifting ring gear 163. The sub base 164 is a semi-circular plate fixed to a position slightly separated from and at the upper side of the base 120.

Referring to FIG. 11, the turntable 140 includes a base plate 141, a floor plate 142, the upper plate 143, and a clearance 144 between the floor plate 142 and the upper plate 143 to receive the tape cartridge 10. The base plate 141 is screwed onto the cylindrical stand 162 (FIG. 10).

Referring to FIG. 10, the lifting mechanism 150 includes a stepping motor 151, a gear train 152, and the lifting ring gear 163. Both the stepping motor 151 and the gear train 152 are provided on the base plate 141.

As shown in FIG. 8, the turntable rotating mechanism 160 includes a stepping motor 165, a reduction gear train 166, and the rotating ring gear 161, all of which are provided on the sub base 164 (FIG. 9). A two-stage gear 166-3, which is the last stage gear of the reduction gear train 166, comprises a large-diameter gear section 166-3a and a small-diameter gear section 166-3b.

The lifting mechanism 150 has a function of initializing the turntable 140 by lifting/lowering the turntable 140 to a home position thereof in the Z direction. The turntable rotating mechanism 160 has a function of initializing the turntable 140 by rotating the turntable 140 to the home position in the rotation direction. The home position of the turntable 140 is a position where a y-axis (described later) becomes parallel to the Y-axis. The lifting mechanism initialization operation and the turntable rotating mechanism initialization operation apply a method of moving an object to an operation end position defined as a reference position, and then moving the object back by a predetermined distance. The same method is applied to operations for initializing a media cartridge transport mechanism 170 (described below).

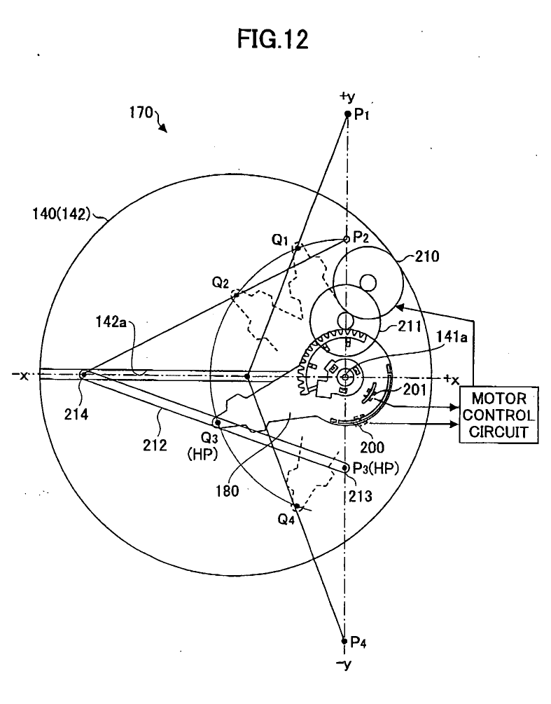

Referring to FIG. 11, the turntable 140 includes the base plate 141, the floor plate 142, the upper plate 143, and the clearance 144 between the floor plate 142 and the upper plate 143 to receive the tape cartridge 10. Referring to FIG. 12, the turntable 140 has coordinates applied wherein the position of a pin 141a (to be described below) is defined as the origin, a guide groove 142a (to be described below) is defined as an x-axis, and an axis passing through the origin and being orthogonal to the x-axis is defined as a y-axis.

The tape cartridge transport mechanism 170 and a stepping motor 210 (described later), both shown in FIG. 12, are provided on the base plate 141 (FIG. 11).

The tape cartridge transport mechanism 170 moves the tape cartridge 10 between a position on the turntable 140, i.e., a position inside the clearance 144, and a position outside the tape cartridge picker 102. In one embodiment, the movement of the tape cartridge by the tape cartridge transport mechanism 170 can be substantially linear. Alternatively, the movement of the tape cartridge 10 can combine linear and non-linear movements. The tape cartridge transport mechanism 170 includes a rotary arm 180 rotatably attached to the pin 141a formed on the base plate 141, the stepping motor 210 (FIG. 12) configured to reciprocally rotate the rotary arm 180 between positions Q1 and Q4 within a predetermined angular range, a reduction gear mechanism 211 configured to transmit the rotation of the motor 210 at a reduced rotation rate to the rotary arm 180, and a lever 212 with a center part rotatably connected to a tip end of the rotary arm 180. A cartridge pin 213 is vertically fixed to an end of the lever 212, while a pin 214 is fixed to the other end of the lever 212. The pin 214 engages a guide groove 142a formed on a lower face of the floor plate 142. In one embodiment, the guide groove 142a can be substantially linear. Alternatively, the guide groove can be curved or can have another suitable configuration.

In one embodiment, the turntable rotating mechanism 160 rotates the turntable 140 every 90 degrees in the clockwise direction or the counterclockwise direction with respect to the home position such that the orientation of the tape cartridge 10 is changed. In non-exclusive alternative embodiments, the turntable can be rotated less than or greater than 90 degrees in either direction. The tape cartridge transport mechanism 170 retrieves the tape cartridge 10 and transports it onto and off of the turntable 140 (see FIG. 3) while the cartridge pin 213 is engaged in the notch 15a of the tape cartridge 10 (FIG. 1).

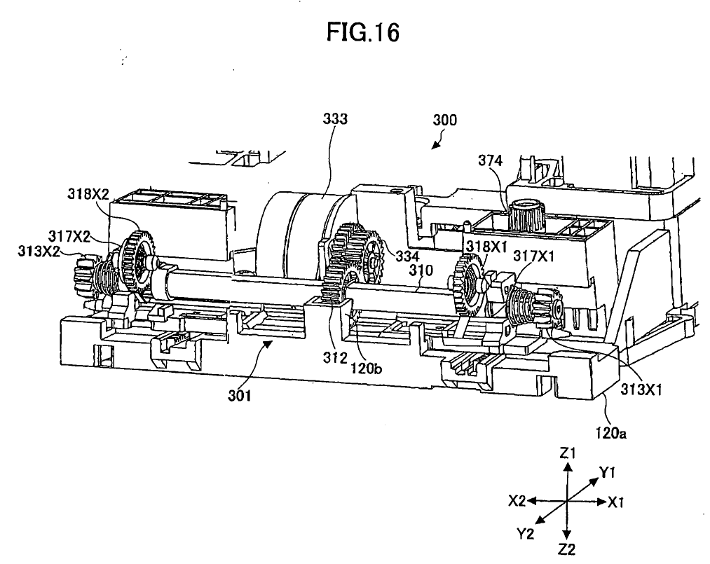

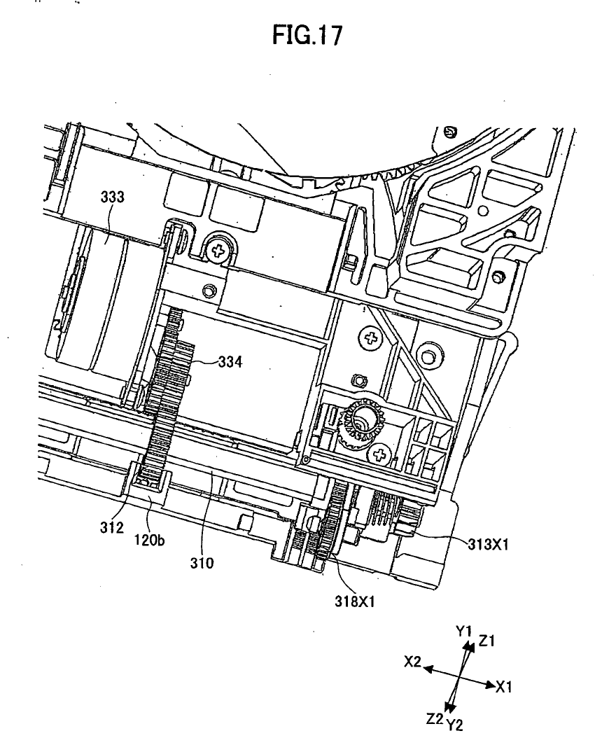

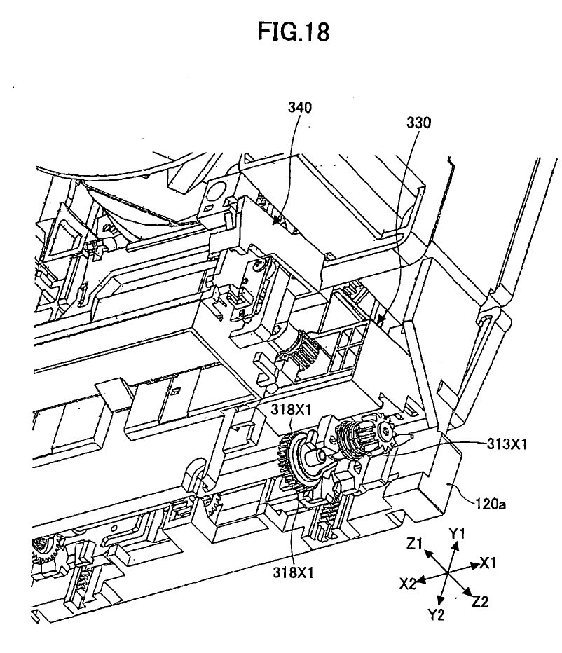

4 [Configuration of Tape Cartridge Transport Magazine Drive 300] (FIGS. 4-6, FIGS. 13-20)

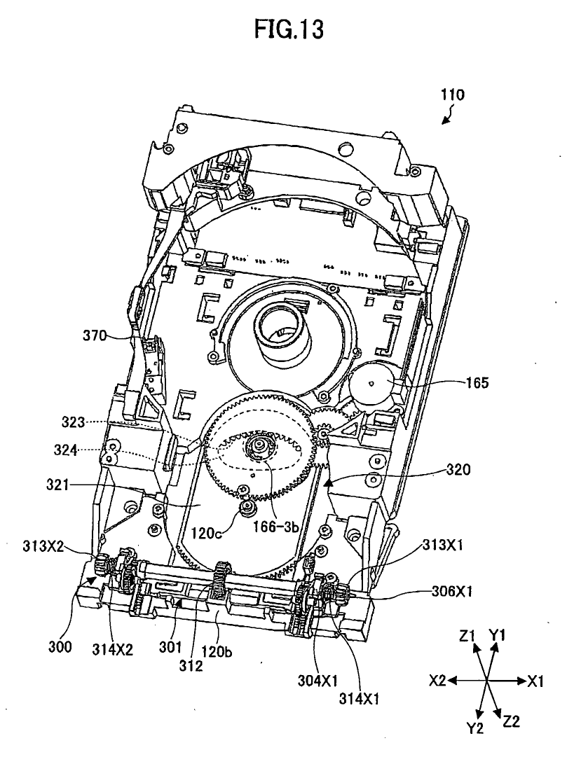

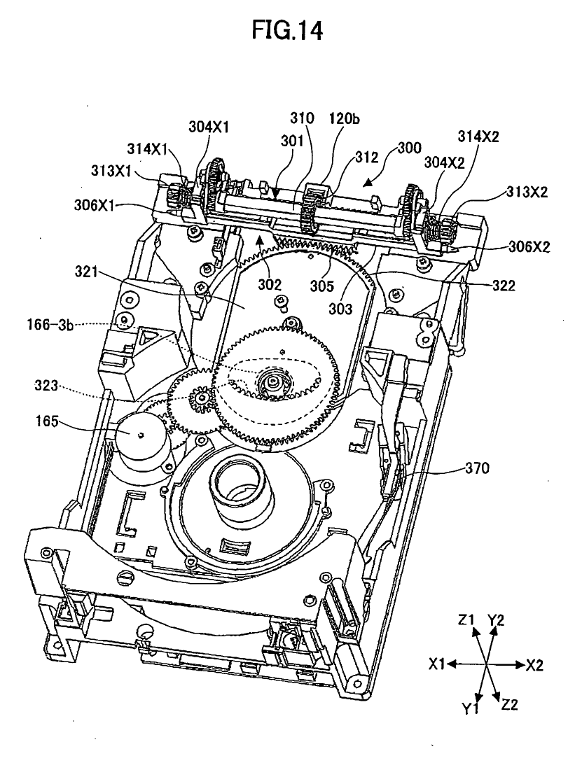

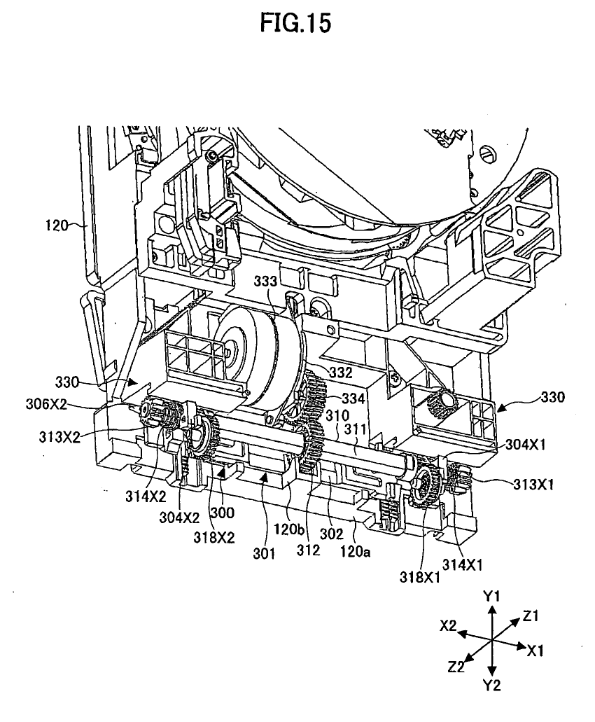

FIG. 13 is a perspective view of the main module 110 with the tape cartridge picker 102, the mail slot module 340, and the motor module 330 removed, viewed from the Y2 side. FIG. 14 is a perspective view of the main module 110 of FIG. 13, viewed from the Y1 side. FIG. 15 is a perspective view of a Y2-side part of the main module 110 with the mail slot module 340 removed.

With reference to FIGS. 4, 5, and 13-15, the magazine drive 300 comprises the drive shaft unit 301, the drive shaft unit shift mechanism 320, and the magazine drive motor module 330.

4-1 [Configuration of Drive Shaft Unit 301]

Referring to FIGS. 5, 6, and 13-18, the drive shaft unit 301 comprises a frame 302, a drive shaft 310, a center gear 312, drive gears 313X1 and 313X2 disposed one on each end, and is installed on the base 120 movably in the X1-X2 direction. FIGS. 5, 6, and 13-18 show the drive shaft unit 301 located at its home position.

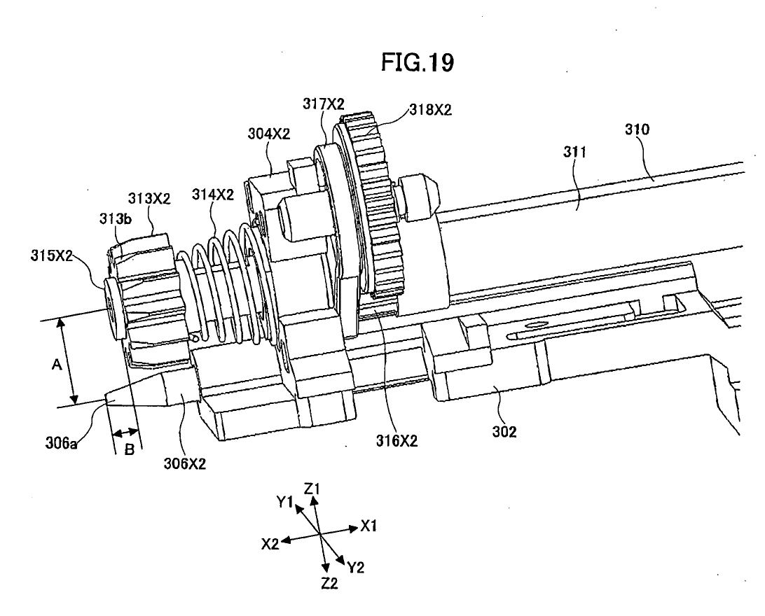

The frame 302 (FIG. 15) comprises a frame main body 303 (FIG. 14) elongated in the X1-X2 direction, flanges 304X1 and 304X2 formed one at each end of the frame main body 303, a rack 305 (FIG. 14) at the center of the frame main body 303, and positioning pins 306X1 and 306X2 provided one on each end of the frame main body 303. Each of the positioning pins 306X1 and 306X2 includes a conical section 306a (FIG. 19). The frame 302 is disposed on the extension 120a of the base 120 movably in the X1-X2 direction.

The drive shaft 310 is rotatably supported at both ends by the flanges 304X1 and 304X2. Gears 316X1 and 316X2 (FIG. 19) are secured to the drive shaft 310 at the inner side of the flanges 304X1 and 304X2. The gears 316X1 and 316X2 prevent the drive shaft 310 from moving with respect to the flanges 304X1 and 304X2 in the X1-X2 direction. The drive shaft 310 has a flat face 311 in its diametrical direction at least at the center and ends thereof so as to have a D-shaped cross section, on which the center gear 312 fits. The drive shaft 310 is configured to rotate with the center gear 312 and is movable in the X1-X2 direction with respect to the center gear 312. In one embodiment, as the center gear 312 is fitted in a holder section 120b formed integrally on the base 120, the movement of the center gear 312 in the X1-X2 direction is restricted.

The drive gears 313X1 and 313X2 are attached to the drive shaft 310 at the outer side of the flanges 304X1 and 304X2, respectively. The drive gears 313X1 and 313X2 are configured to rotate with the drive shaft 310, and are slidable along the drive shaft 310 in the axial direction of the drive shaft 310. Washers 315X2 (FIG. 19) can be threaded on the end faces of the drive shaft 310 to prevent the drive gears 313X1 and 313X2 from dropping off. Compression coil springs 314X1 and 314X2 are wound around the drive shaft 310 between the drive gears 313X1, 313X2 and the flanges 304X1, 304X2, respectively. The drive gear 313X2 compresses the compression coil spring 314X2 to move in the X1 direction when a force in the X1 direction is applied to the drive gear 313X2. The drive gear 313X1 compresses the compression coil spring 314X1 to move in the X2 direction when a force in the X2 direction is applied to the drive gear 313X1.

As shown in detail in FIG. 19, there is a distance A between the positioning pin 306X2 and the drive shaft 310. The positioning pin 306X2 extends further outward than the drive gear 313X2 by a distance B. The drive gear 313X2 is a spur gear having a taper face 313b on the outer end. The drive gears 313X1 and the positioning pin 306X1 also have the configurations as described above.

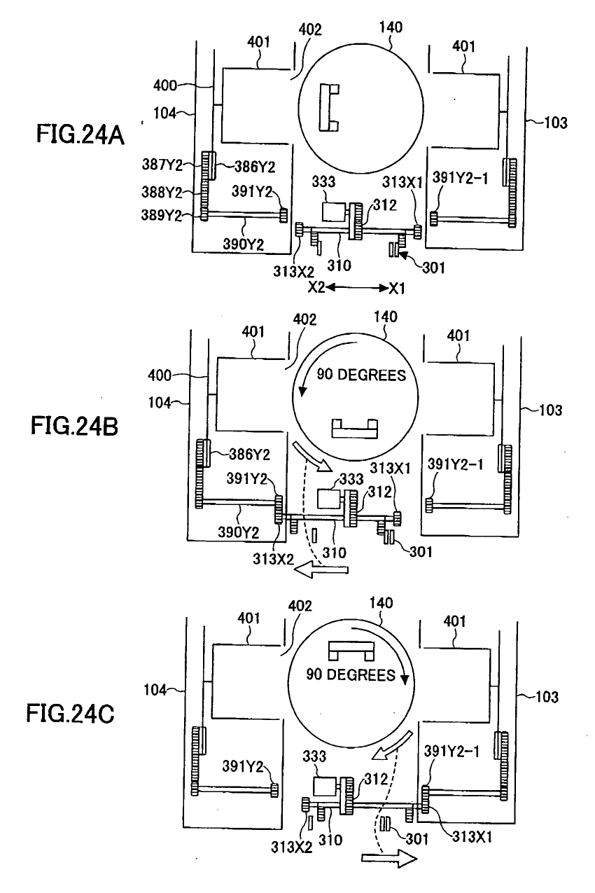

The drive shaft unit 301 is usually located at a home (center) position shown in FIGS. 4 and 24A. When the drive shaft unit 301 is at the home position, the positioning pins 306X1 and 306X2 are located within the width of the base 120 in the X1-X2 direction.

Swing arms 317X1 and 317X2 are attached to the drive shaft 310 between the gears 316X1, 316X2 and the flanges 304X1, 304X2, respectively. Gears 318X1 and 318X2 are attached to ends of the swing arms 317X1 and 317X2. The gears 318X1 and 318X2 mesh with the gears 316X1 and 316X2, respectively. The swing arms 317X1 and 317X2 swing in the same direction as the drive shaft 310 rotates.

4-2 [Configuration of Drive Shaft Unit Shift Mechanism 320]

The drive shaft unit shift mechanism 320 utilizes the stepping motor 165 that rotates the turntable 140. The drive shaft unit shift mechanism 320 comprises the stepping motor 165 and a gear member 321 (see FIGS. 13 and 14).

The gear member 321 has a generally elliptical shape, comprising an outer gear section 322 and an inner gear section 323 along the edge of an inner opening 324. A center hole of the gear member 321 fits on a shaft portion 120c of the base 120. The inner gear section 323 meshes with the small-diameter gear section 166-3b, while the outer gear section 322 meshes with the rack 305 (FIG. 14).

When the stepping motor 165 is driven, the turntable 140 is rotated through the gear train 166. At the same time, the gear member 321 is rotated thought the small-diameter section 166-3b in the clockwise direction or the counterclockwise direction in accordance with the rotational direction of the stepping motor 165, so that the drive shaft unit 301 is moved through the rack 305 in the X2 direction or the X1 direction.

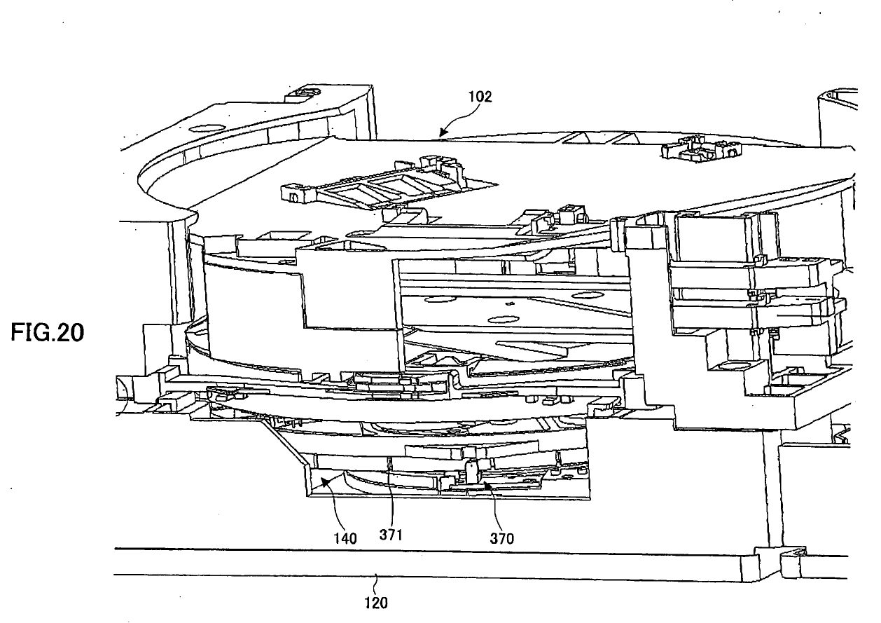

Referring to FIG. 20, the photo sensor 370 for detecting the rotating angle of the turntable 140 is provided. The photo sensor 370 detects the rotating angle of the turntable 140 by detecting slits 371, which can be formed in a predetermine arrangement on a rib around a lower face of the turntable 140. In one embodiment, the rotating angle of the turntable 140 and the moving distance of the drive shaft unit 301 have the following relation: When the rotating angle of the turntable 140 is approximately 15 degrees, the moving distance of the drive shaft unit 301 is approximately 2.5 mm; when the rotating angle of the turntable 140 is approximately 30 degrees, the moving distance of the drive shaft unit 301 is approximately 5 mm; and when the rotating angle of the turntable 140 is approximately 90 degrees, the moving distance of the drive shaft unit 301 is approximately 15 mm. However, it is recognized that other suitable arrangements can be utilized with the present invention depending upon the design requirements of the autoloader.

4-3 [Configuration of Magazine Drive Motor Module 330]

As shown in FIG. 5, in the magazine drive motor module 330, the magazine drive motor 333 is secured to a flange section 332 of a frame 331. A reduction gear 334 is held in the flange section 332. The reduction gear 334 meshes with a gear 335 secured to a spindle of the magazine drive motor 333.

The magazine drive motor module 330 is secured to the Y1-side end of the base 120 such that the reduction gear 334 meshes with the gear 312 as shown in FIG. 15.

When the magazine drive motor 333 is driven, the gear 312 is rotated through the reduction gear 334. Accordingly, the drive shaft 310 and the drive gears 313X1 and 313X2 are rotated.

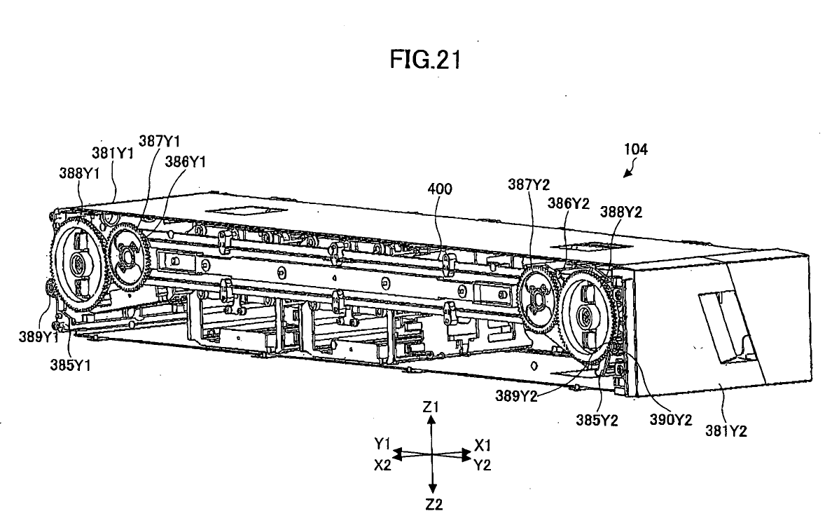

5 [Configuration of Tape Cartridge Transport Magazines 103, 104] (FIGS. 21-23)

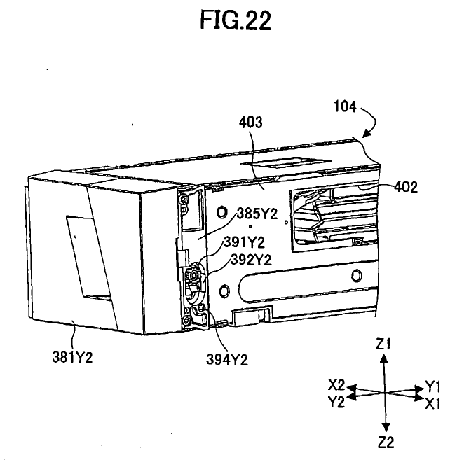

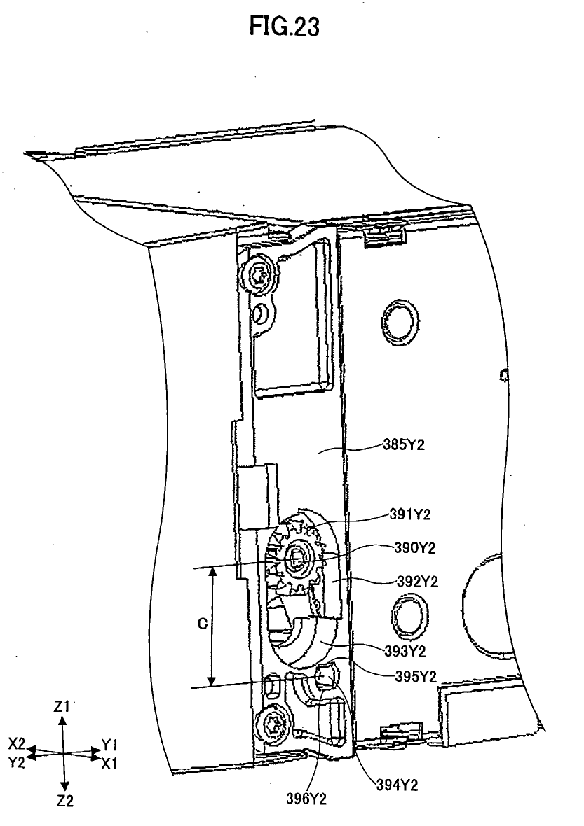

FIG. 21 is a perspective view of the tape cartridge transport magazine 104 with an X2-side lateral plate removed, viewed from the X2 side. FIG. 22 is a perspective view of the tape cartridge transport magazine 104 of FIG. 21, viewed from the X1 side. FIG. 23 is an enlarged view illustrating a part of the tape cartridge transport magazine 104 of FIG. 22

Referring to FIG. 21, the tape cartridge transport magazine 104 is a quadrangular prism elongated in the Y1-Y2 direction and comprises decorative panels 381Y1 and 381Y2 at opposing ends in the longitudinal direction. In one embodiment, the tape cartridge transport magazine 104 can be installable at both the X1 side and the X2 side of the main module 110 by reversing the longitudinal orientation without turning it upside down. Alternatively, the tape cartridge transport magazine 104 can be positioned and/or oriented differently relative to the main module 110.

As shown in FIG. 21, a frame 385Y2, a pulley 386Y2, a large-diameter gear member 388Y2 that meshes with a gear section 387Y2 provided at the end of the pulley 386Y2, and a small-diameter gear member 389Y2 that meshes with the large-diameter gear member 388Y2 are provided at the Y2 side. The small-diameter gear member 389Y2 is secured to an end of a rotary shaft 390Y2.

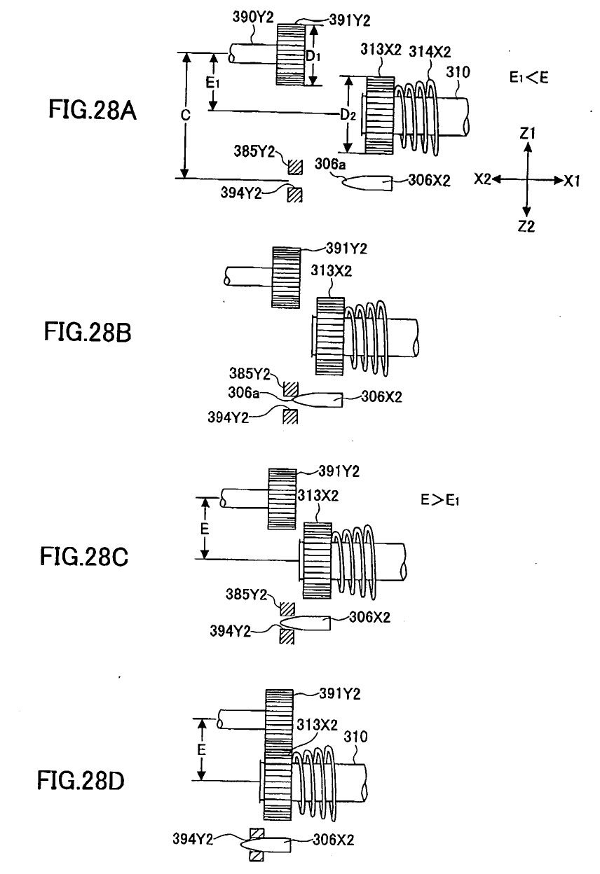

As shown in FIGS. 22 and 23, a small-diameter magazine gear 391Y2 is secured to the opposite end of the rotary shaft 390Y2. An opening 392Y2 elongated in the z direction is formed in the frame 385Y2. The magazine gear 391Y2 is exposed from a Z1-side part of the opening 392Y2. The opening 392Y2 includes an opening portion 393Y2 having a size that allows the drive gear 313X2 to be fitted therein. A positioning hole 394Y2 is formed at the Z2 side of the opening portion 393Y2 in the frame 385Y2. The positioning hole 394Y2 is elongated in the Y1-Y2 direction and includes linear edges 395Y2 and 396Y2 at the Z1 side and the Z2 side, each extending in the Y1-Y2 direction. The positioning hole 394Y2 is formed at the Z2 side of the magazine gear 391Y2 with a distance C therebetween (see FIG. 28A). The distance C is determined based on the distance A, a pitch circle diameter D1 of the magazine gear 391Y2, and a pitch circle diameter D2 of the drive gear 313X2 such that the center distance between the magazine gear 391Y2 and the drive gear 313X2 is set to an appropriate value E when the positioning pin 306X2 (FIG. 19) is fitted in the positioning hole 394Y2.

Referring back to FIG. 21, a frame 385Y1 a pulley 386Y1, a gear section 387Y1, a large-diameter gear member 388Y1, a small-diameter gear member 389Y1, and a magazine gear are provided at the Y1 side similar to the Y2 side.

Plural tape cartridge containers (also referred to as ‘carriers’) 401 are disposed at even intervals on a timing belt (belt) 400 extending around the pulleys 386Y1 and 386Y2 (see FIGS. 2 and 21).

An opening 402 (FIG. 22) having a size corresponding to the tape cartridge 10 is formed in an X2-side lateral plate 403 of the magazine 104 so as to oppose the tape cartridge picker 102 when the magazine 104 is mounted. Also, openings (not shown) for inserting tape cartridges 10 are formed in the lateral plate 403 of the magazine 104 so as to oppose the corresponding tape cartridge containers 401 (FIG. 2).

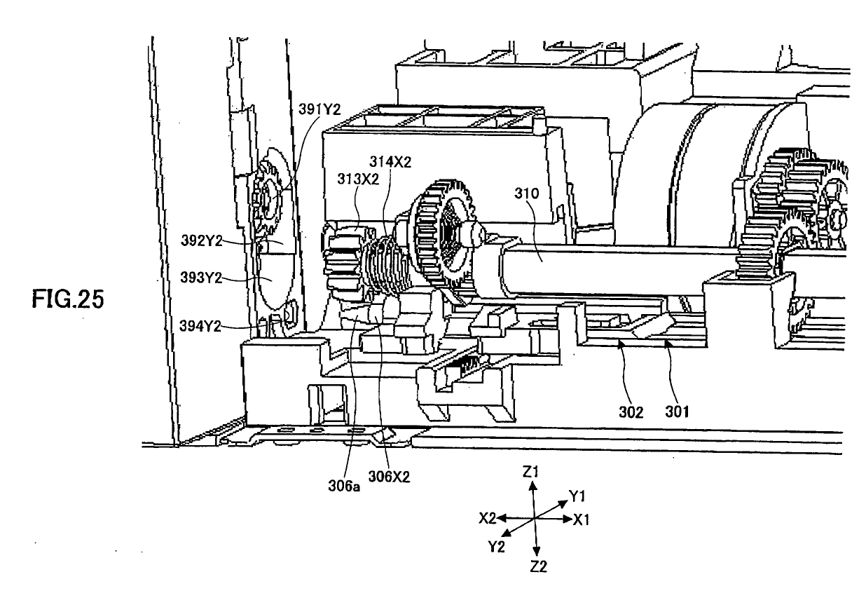

When the tape cartridge transport magazines 103 and 104 are attached at the X1 side and the X2 side as shown in FIG. 1, the drive shaft unit 301 can be located at the home position shown in FIG. 24A. At the X2 side, as shown in FIG. 25, the magazine gear 391Y2, the opening 392Y2, and the positioning hole 394Y2 oppose the drive gear 313X2 (313X1) and the positioning pin 306X2 (306X1). The opening 402 opposes the tape cartridge picker 102.

6 [Operations for Selectively Driving Tape Cartridge Transport Magazines 103, 104] (FIGS. 24A-29D)

FIG. 24B shows a state to drive the tape cartridge transport magazine 104. FIG. 24C shows a state to drive the tape cartridge transport magazine 103.

When a command to drive the tape cartridge transport magazine 104 is input, the stepping motor 165 is driven in the normal direction by the motor control circuit 410 so as to drive the magazine drive motor 333 (see FIG. 4).

When the stepping motor 165 is driven, the turntable 140 is rotated in the counterclockwise direction through the reduction gear train 166 (FIG. 9). At the same time, the drive shaft unit 301 is driven in the X2 direction through the gear member 321 (FIG. 13) and the rack 305. The stepping motor 165 is stopped at the time when the photo sensor 370 (FIG. 20) detects that the turntable 140 is rotated by a predetermined amount, such as 90 degrees in the counterclockwise direction. The drive shaft unit 301 is moved in the X2 direction, so the drive gear 313X2 is inserted into the opening portion 393Y2 to mesh with the magazine gear 391Y2. Thus, the magazine drive 300 establishes a rotation transmission path from the magazine drive motor 333 to the tape cartridge transport magazine 104.

The stepping motor 165 for rotating the turntable 140 is also used for moving the drive shaft unit 301. Therefore, there is no need to provide a stepping motor exclusively used for moving the drive shaft unit 301. It is so designed that the tape cartridge picker 102 is at rest while the tape cartridge transport magazine 104 is driven. According to the present embodiment, a part of the resting tape cartridge picker 102 is operated for moving the drive shaft unit 301.

As the drive shaft unit 301 is interlocked with the turntable 140, the moving distance of the drive shaft unit 301 is found by detecting the rotating angle of the turntable 140. Therefore, there is no need to provide the drive shaft unit 301 with a mechanism for detecting the moving distance.

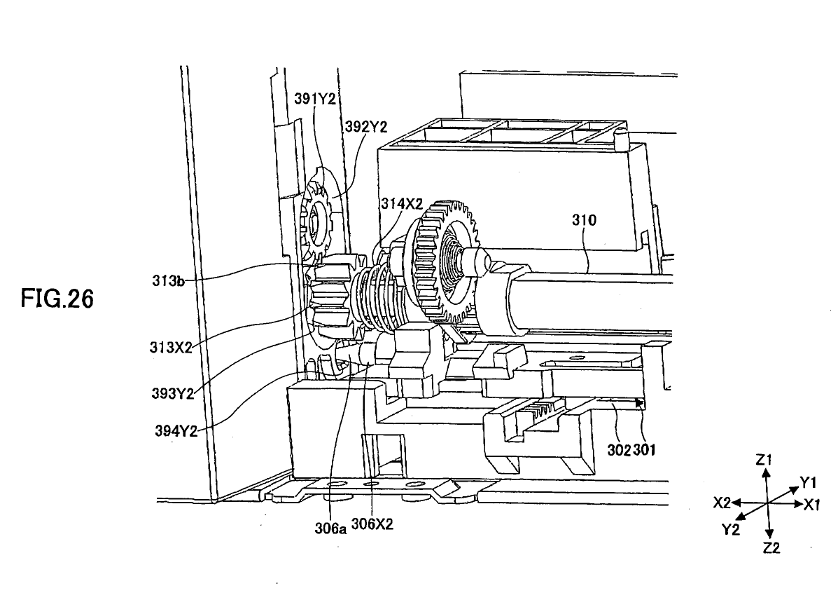

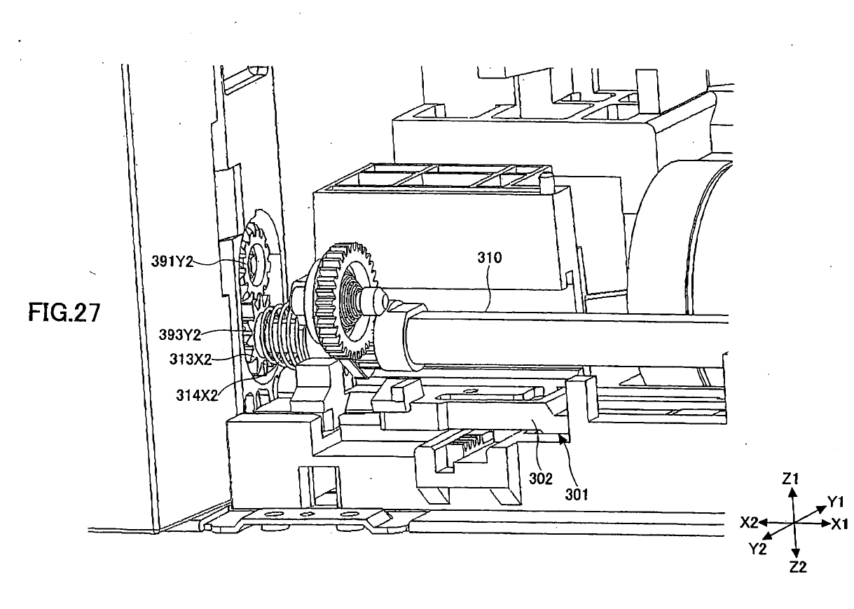

At the final stage of the movement of the drive shaft unit 301 in the X2 direction, the following operations illustrated in FIGS. 26 and 27 are performed,

Just before the drive gear 313X2 contacts the magazine gear 391Y2, the positioning pin 306X2 fits into the positioning hole 394Y2 (see FIGS. 26, 28B, and 28C) so as to set the center distance between the magazine gear 391Y2 and the drive gear 313X2 to the appropriate value E (e.g., FIG. 28C). When the drive shaft unit 301 is further moved in the X2 direction to be inserted into the opening portion 393Y2 from the lateral side thereof, tooth sections of the drive gear 313X2 fit into tooth groove sections of the magazine gear 391Y2 (see FIGS. 27, 24B, and 28B). Thus, the drive gear 313X2 correctly meshes with the magazine gear 391Y2. The taper face 313b helps the drive gear 313X2 to smoothly mesh with the magazine gear 391Y2.

FIGS. 28A-28D illustrate operations for correcting the center distance between the drive gear 313X2 and the magazine gear 391Y2 to the appropriate value E just before the drive gear 313X2 meshes with the magazine gear 391Y2.

FIG. 28A illustrates the magazine gear 391Y2 and the drive gear 313X2 located at the positions shown in FIGS. 24A and 25. Supposing that the center distance between the magazine gear 391Y2 and the drive gear 313X2 is a value E1 smaller than the appropriate value E. This situation may occur when, for example, the frame 500 is distorted at the time of mounting the tape cartridge autoloader 100 on the rack or when there is an assembly error in the tape cartridge autoloader 100.

When the drive shaft unit 301 is moved in the X2 direction, a tip end of the conical section 306a of the positioning pin 306X2 is inserted into the positioning hole 394Y2 as shown in FIG. 28B and further inserted as shown in FIG. 28C before the drive gear 313X2 reaches the magazine gear 391Y2. During this process, the drive gear 313X2 is slightly moved in the Z2 direction or the tape cartridge transport magazine 104 is slightly moved in the Z1 direction, so that the center distance between the magazine gear 391Y2 and the drive gear 313X2 is corrected to the appropriate value E. After the center distance is corrected to the appropriate value E, the drive gear 313X2 correctly meshes with the magazine gear 391Y2.

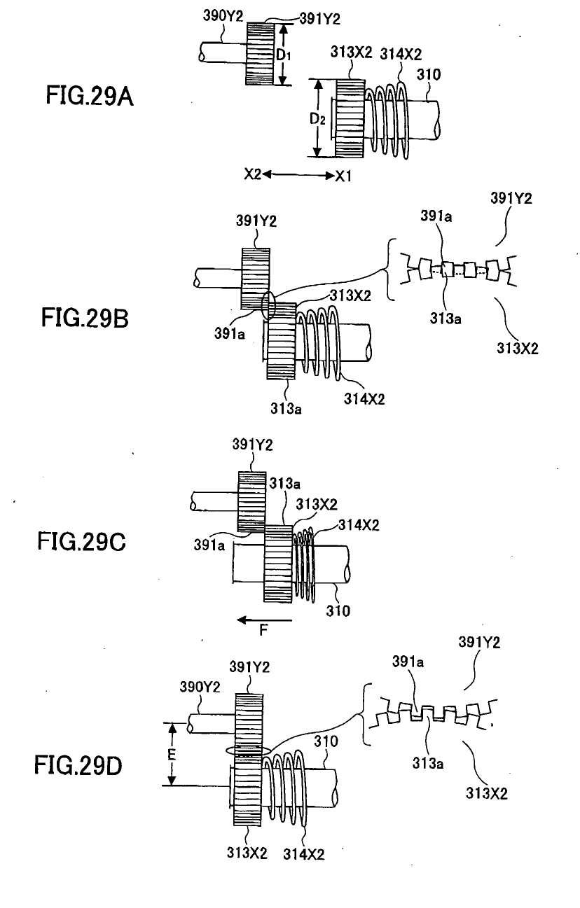

FIGS. 29A-29D illustrate operations for locating the drive gear 313X2 to correctly mesh with the magazine gear 391Y2 when the tooth sections of the drive gear 313X2 contact and interfere with tooth sections of the magazine gear 391Y2.

FIG. 29B illustrates the tooth sections of the drive gear 313X2, which are moved in the X2 direction from the original position shown in FIG. 29A, contacting and interfering with the tooth sections of the magazine gear 391Y2 When the drive shaft unit 301 is further moved in the X2 direction, the compression coil spring 314X2 is compressed as shown in FIG. 29C. Thus, the drive shaft unit 301 is moved to the final position. The drive gear 313X2 is stopped with lateral end faces of the tooth sections 313a abutting opposing lateral end faces of the tooth section 391a of the magazine gear 391Y2.

Then, the magazine drive motor 333 is started as described below, and accordingly the drive gear 313X2 is rotated. When the tooth sections of the rotating drive gear 313X2 oppose the tooth groove sections of the magazine gear 391Y2, the drive gear 313X2 is moved in the X2 direction with a spring force F of the compression coil spring 314X2 so as to correctly mesh with the magazine gear 391Y2 as shown in FIG. 29D.

After the drive gear 313X2 meshes with the magazine gear 391Y2, the gear 312 is rotated by the magazine drive motor 333 through the reduction gear 334. Accordingly, the drive shaft 310, the drive gears 313X1 and 313X2 are rotated. The rotation of the drive gear 313X2 is transmitted to the magazine gear 391Y2, the large-diameter gear member 388Y2, the gear section 387Y2, and to the pulley 386Y2 (FIG. 24A). Thus, the timing belt 400 is driven so as to move the tape cartridge containers 401 together with the tape cartridges 10 stored in the tape cartridge containers 401.

When a command to stop driving the tape cartridge transport magazine 104 is input, the magazine drive motor 333 is stopped. Then, the stepping motor 165 is driven in the reverse direction to rotate the turntable 140 back to the home position. Also, the drive shaft unit 301 is moved in the X1 direction back to the home position shown in FIG. 24A via the gear member 321 and the rack 305.

If a command to drive the tape cartridge transport magazine 103 is input when the drive shaft unit 301 is located at the home position shown in FIG. 24A, the stepping motor 165 is driven in the reverse direction by the motor control circuit 410 (FIG. 4) so as to drive the magazine drive motor 333. Thus, the drive gear 313X1 correctly meshes with a magazine gear 391Y2-1 of the tape cartridge transport magazine 103 (see FIG. 24C) in the same manner as described above. Accordingly, the timing belt 400 is driven by the magazine drive motor 333 so as to move the tape cartridge containers 401.

When a command to stop driving the tape cartridge transport magazine 103 is input, the magazine drive motor 333 is stopped. Then, the stepping motor 165 is driven in the reverse direction to rotate the turntable 140 back to the home position via the gear member 321 and the rack 305. Also, the drive shaft unit 301 is moved in the X2 direction back to the home position shown in FIG. 24A.

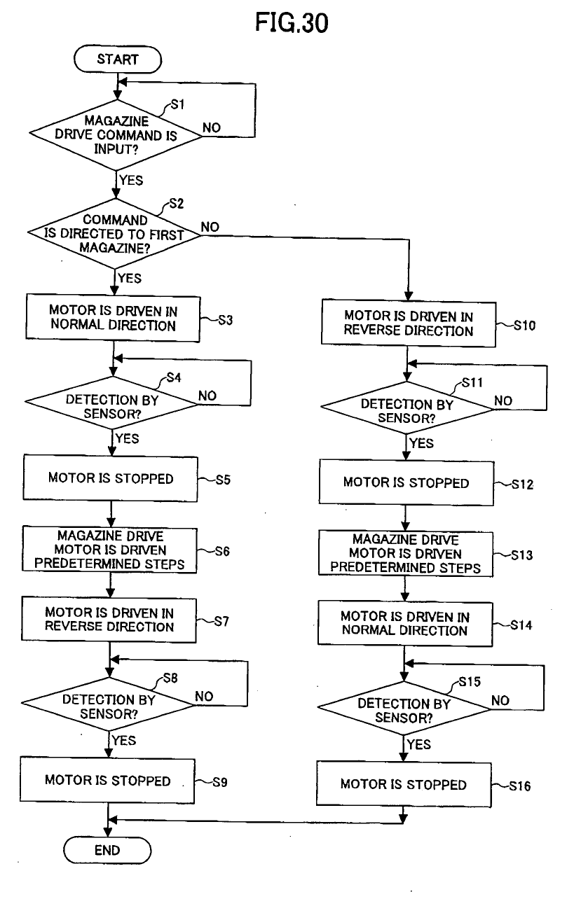

7 [Operations of Microcomputer of Motor Control Circuit 410] (FIG. 30)

The microcomputer of the motor control circuit 410 operates as illustrated in FIG. 30.

When a magazine drive command is input, the microcomputer determines whether the command is directed to the first tape cartridge transport magazine 104 (S1, S2). If the command is directed to the first tape cartridge transport magazine 104, the microcomputer drives the stepping motor 165 in the normal direction. When the photo sensor 370 detects that the turntable 140 is rotated 90 degrees in the counterclockwise direction, the microcomputer stops the stepping motor 165 (S3, S4, S5). After that, the magazine drive motor 333 is driven predetermined steps (S6). The microcomputer then drives the stepping motor 165 in the reverse direction. When the photo sensor 370 detects that the turntable 140 is rotated in the clockwise direction to the home position, the microcomputer stops the stepping motor 165 (S7, S8, S9).

If the command is directed to the second tape cartridge transport magazine 103, the microcomputer drives the stepping motor 165 in the reverse direction When the photo sensor 370 detects that the turntable 140 is rotated 90 degrees in the clockwise direction, the microcomputer stops the stepping motor 165 (S10, S11, S12). After that, the magazine drive motor 333 is driven predetermined steps (S13). The microcomputer then drives the stepping motor 165 in the normal direction. When the photo sensor 370 detects that the turntable 140 is rotated in the counterclockwise direction to the home position, the microcomputer stops the stepping motor 165 (S14, S15, S16).

8 [Transport Mechanism for Tape Cartridge Container 401]

As is described above, the tape cartridge transport magazines 103 and 104 correspond to mechanisms for transporting the tape cartridge containers 401 accommodating the tape cartridges 10 (see FIG. 2). In the tape cartridge transport magazines 103 and 104, plural tape cartridge containers 401 are coupled to the corresponding timing belts 400. Accordingly, a number of tape cartridges 10 equaling the number of tape cartridge containers 401 coupled to the timing belts 400 may be accommodated in the tape cartridge transport magazines 103 and 104 at a single point in time.

In the following, a configuration of the tape cartridge container 401 is described, and a configuration of a container transport mechanism 430 is described thereafter.

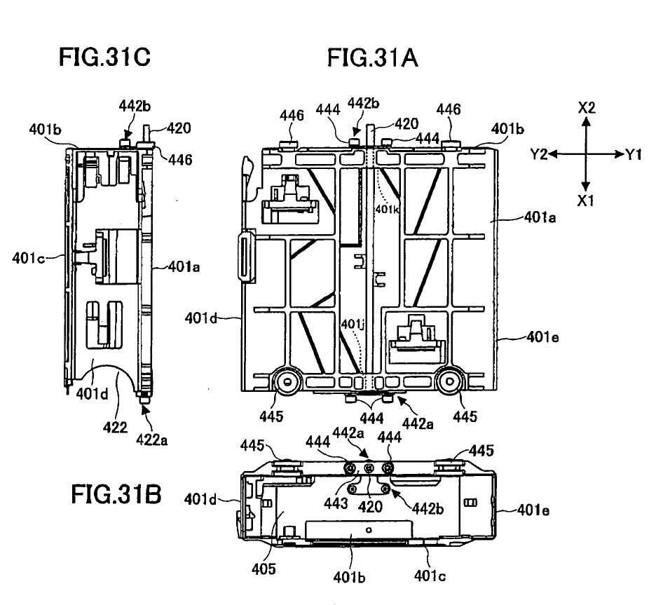

FIGS. 31A through 31C are diagrams showing one embodiment of the tape cartridge container 401; namely, FIG. 31A is a plan view, FIG. 31B is an elevation view, and FIG. 31C is a side view of the tape cartridge container 401. In the embodiment shown in FIGS. 31A through 31C, the tape cartridge container 401 includes a top plate 401a, a back plate 401b, a bottom plate 401c, and side plates 401d and 401e that surround the respective sides of a cartridge accommodating space 405 other than the side at which an opening 422 is formed. At the top plate 401a, through holes 401j and 401k are arranged to extend in the X1-X2 directions along the center line of the top plate 401a, and a metal shaft 420 is inserted through the through holes 401j and 401k.

The ends of the shaft 420 are arranged to protrude from the front side edge and the rear side edge of the top plate 401a, and belt coupling members (not shown) and one or more roller members 442a and 442b are attached to the ends of the shaft 420. Also, one or more rollers 445 (two rollers 445 are shown in FIG. 31A) configured to rotate the lateral plate 403 (see FIG. 22) are rotatably arranged at the opening 422 side of the top plate 401a. Further, one or more rollers 446 (two rollers 446 are shown in FIG. 31A) configured to rotate a lateral plate (not shown) supporting the timing belt 400 are arranged at the back plate 401b.

In this embodiment, the rollers 445 positioned at the front side are arranged to rotate when the tape cartridge container 401 moves horizontally, and the rollers 446 positioned at the rear side are arranged to rotate when the tape cartridge container 401 moves vertically (up/down).

One end of the shaft 420 can be supported by a container transport mechanism (described below) and can be arranged to have a driving force in the transporting direction transmitted thereto. The other end of the shaft 420 can be supported by a container guide mechanism (described below) and can be arranged to be guided in the transporting direction. The tape cartridge container 401 is transported in a suspended state so that it may oscillate with respect to the shaft 420. Further, in this embodiment, the rollers 445 and 446 are arranged to roll across the lateral plates of the tape cartridge transport magazines 103 and 104 when the tape cartridge container 401 is transported so as to maintain a stable state preventing the shaft 420 from slanting.

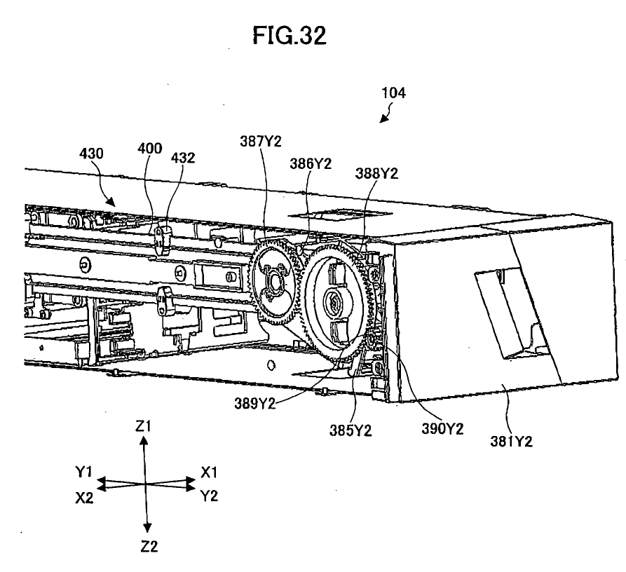

FIG. 32 is a perspective view of the container transport mechanism 430. It is noted that in FIG. 32, only the Y2 side of the tape cartridge transport magazine 104 is shown, and an illustration of the Y1 side is omitted. As is shown in FIG. 32, the container transport mechanism 430 includes the pulleys 386Y1 and 386Y2, the gear sections 387Y1 and 387Y2, the large-diameter gear members 388Y1 and 388BY2, small-diameter gear members 389Y1 and 389Y2, the timing belt 400, and a belt coupling member 432 that is coupled to the timing belt 400.

In this embodiment, the belt coupling member 432 is engaged with and fixed to one end of the shaft 420. This end of the shaft 420 may be chamfered into a non-circular D-shape, for example, so that its relative movement in the rotating direction with respect to the belt coupling member 432 may be controlled.

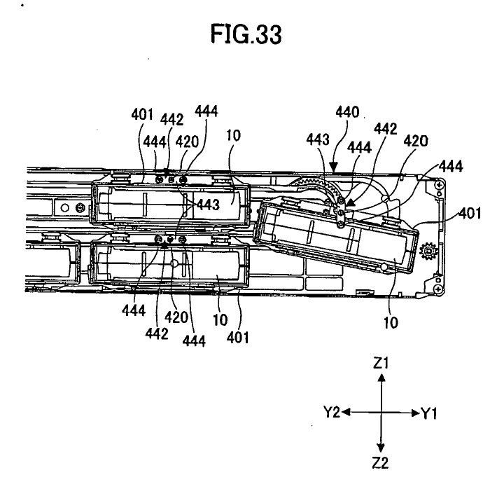

FIG. 33 is a perspective view of a container guide mechanism 440. As is shown in FIG. 33, the container guide mechanism 440 includes a roller member 442 that is rotatably engaged with the other end of the shaft 420, and a guide groove (not shown) for guiding the movement of the roller member 442. The roller member 442 includes a metal plate 443 that extends in perpendicular directions with respect to the extending direction of the shaft 420, and one or more rollers 444 (a pair of rollers 444 is shown for each container guide mechanism 440 in FIG. 33) that are arranged around the ends of the metal plate 443.

The pair of rollers 444 are arranged to roll along the guide groove (not shown) to thereby transport the tape cartridge container 401. In one embodiment, the guide groove is arranged into a somewhat oval loop along the transporting path of the tape cartridge container 401. However, the guide groove can be arranged in a different shape that can be varied depending upon the design requirements of the autoloader 100 and the tape cartridge transport magazines 103 and 104. When the pair of rollers 444 passes the arc-shaped curved portion of the guide groove, the roller member 442 may oscillate with respect to the shaft 420 so that the tape cartridge container 401 may be transported in a slightly slanted state.

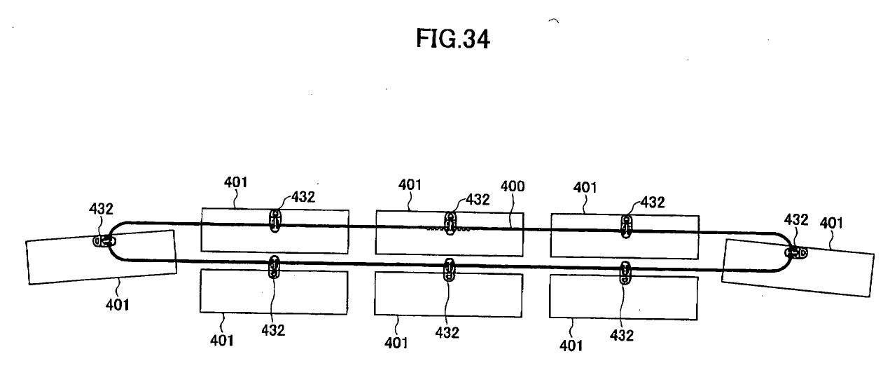

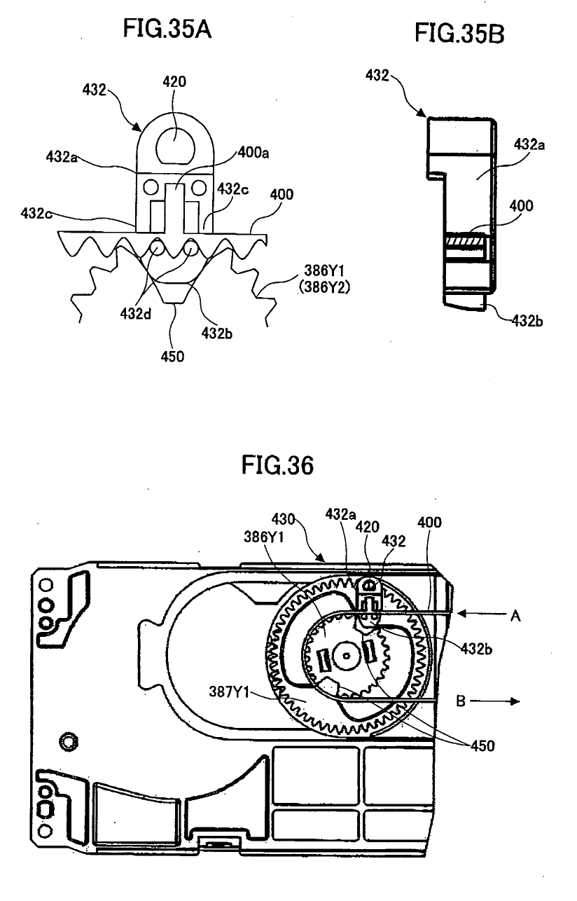

In the following, configurations of the belt coupling member 432 and its attaching structure are described. FIG. 34 is a diagram illustrating a state in which the tape cartridge container 401 is coupled to the timing belt 400 via the belt coupling member 432. FIGS. 35A and 35B are enlarged views of the attaching structure of the belt coupling member 432, FIG. 35A corresponding to an elevation view, and FIG. 35B corresponding to a side view.

As is shown in FIG. 34, in the present example, eight tape cartridge containers 401 are coupled to the somewhat oval-loop-shaped timing belt 400 at predetermined intervals, and the coupling of the tape cartridge containers 401 to the timing belt 400 is realized via the belt coupling members 432. It is recognized that although the embodiment in FIG. 34 includes eight tape cartridge containers 401, any suitable number of containers 401 can be included in each of the one or more tape cartridge transport magazines 103, 104.

When the belt coupling member 432 passes the horizontally extending portion of the oval-loop-shaped timing belt 400, it moves in a horizontal direction at an upright state (i.e., perpendicular to the timing belt 400). In this case, the load of the tape cartridge container 401 acts on the timing belt 400 in a perpendicular direction (i.e., the direction for pushing the timing belt 400 onto the pulleys 386Y1 and 386Y2), and thereby, stability may be maintained in the traveling motion of the timing belt 400.

In the embodiment shown in FIGS. 35A and 35B, the belt coupling member 432 can be made of any suitable materials, such as molded resin, plastics, metals, etc., and can be integrally molded with the timing belt 400 through outsert molding. Alternatively the belt coupling member 432 can be separately formed from the timing belt 400. In this embodiment, the belt coupling member 432 includes an outer protruding section 432a that engages with a protrusion 400a that protrudes toward the outer side of the timing belt 400, an inner protruding section 432b that protrudes toward the inner side of the timing belt 400, outer abutting sections 432c that abut on the outer side of the timing belt 400, and inner abutting sections 432d that abut teeth formed at the inner side of the timing belt 400. Also, the tip portion of the outer protruding section 432a is engaged with one end of the shaft 420 (e.g., the D-shaped end of the shaft 420) to realize an integrally coupled structure.

In the embodiment illustrated in FIG. 36, the tape cartridge transport magazine 103, 104 includes an engaging mechanism that releasably engages the inner protruding section 432b. In one embodiment, the engaging mechanism includes one or more concave engaging sections 450 that are arranged at a predetermined interval, e.g., approximately 180-degree interval, around one or more of the pulleys 386Y1 and 386Y2 that drive the timing belt 400. It is understood that this predetermined interval can be greater or less than 180 degrees, depending upon the design requirements of the autoloader 100. In one embodiment, the concave engaging sections 450 are somewhat trapezoidal in shape, although this shape can deviate from the configuration shown in the figures to suit the needs of the autoloader 100 and the tape cartridge transport magazine 103, 104. In this embodiment, the concave engaging section 450 rotates so as to enable smooth engagement with the inner protruding section 432b, and has a curved structure that widens outward so as to enable smooth detachment of the inner protruding section 432b.

Further, in this embodiment, the inner protruding section 432b is arranged into a reversed-trapezoidal shape and is configured to be mechanically held by engaging with the concave engaging section 450 of the pulley 386Y1/386Y2 to support the load W of the tape cartridge 10 and the tape cartridge container 401.

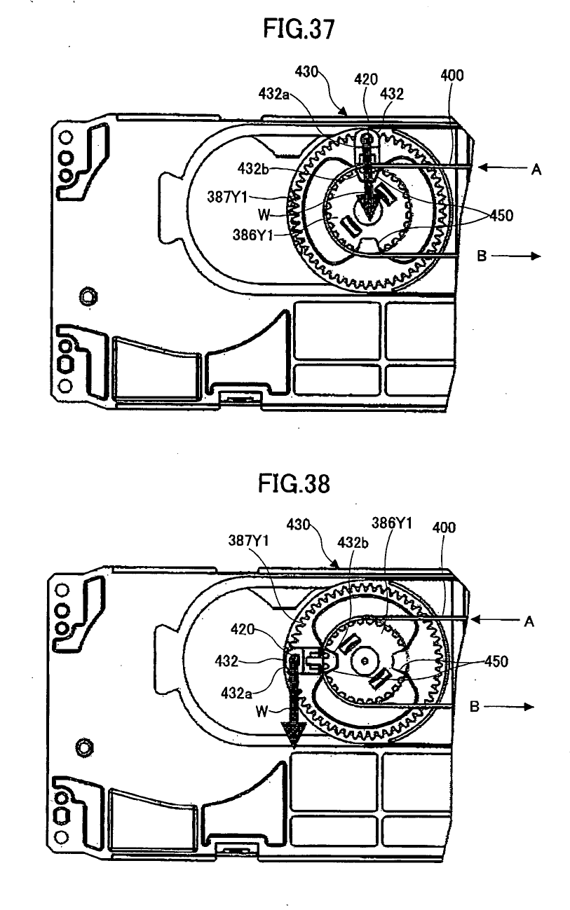

In the following, operations for engaging the belt coupling member 432 with the pulley 386Y1 are described. FIG. 36 is a diagram illustrating an operating state before engagement of the belt coupling member 432 with the pulley 386Y1. FIG. 37 is a diagram illustrating an engaged state between the belt coupling member 432 and the pulley 386Y1. FIG. 38 is a diagram illustrating a state in which the belt coupling member 432 and the pulley 386Y1 are rotated by approximately 90 degrees in an engaged state.

As is shown in FIG. 36, the timing belt 400 engages with the gear section at the periphery of the pulley 386Y1, and thereby, when the pulley 386Y1 is rotated in a counter-clockwise direction, the portion of the timing belt 400 extending over the pulley 386Y1 at the upper side is wound toward direction A. Also, since the timing belt 400 is arranged into a somewhat oval loop shape as is shown in FIG. 34, the portion of the timing belt 400 extending over the pulley 386Y1 at the lower side is wound toward direction B.

The belt coupling member 432 moves in the running direction of the timing belt 400 to approach the periphery of the pulley 432Y1 so that the inner protruding section 432b may be received into the concave engaging section 450 to realize engagement between the inner abutting section 432d and the concave engaging section 450.

As is shown in FIG. 37, the inner protruding section 432b may be substantially engaged with the concave engaging section 450 when the belt coupling member 432 is positioned on the rotational axis of the pulley 386Y1. At this point, the load W of the tape cartridge 10 and the tape cartridge container 401 acts downward in a perpendicular direction with respect to the running direction of the timing belt 400. Therefore, a moment does not act on the belt coupling member 432, and the tape cartridge container 401 that is supported via the belt coupling member 432 may be suspended in a stable state.

As is shown in FIG. 38, when the pulley 386Y1 is rotated by approximately 90 degrees in the counter-clockwise direction, the belt coupling member 432 rotates from a perpendicular state to a horizontal state, and the load W of the tape cartridge 10 and the tape cartridge container 401 acts downward in a perpendicular direction with respect to the belt coupling member 432 via the shaft 420. In this way, a moment acts on the belt coupling member 432 that induces separation of the timing belt 400 from the periphery of the pulley 386Y1.

However, since the inner protruding section 432b is engaged with the concave engaging section 450, the moment may be received by the concave engaging section 450 and the belt coupling member 432 may be maintained in a horizontal state. In this way, the tape cartridge container 401 may be lowered toward the lower side of the pulley 386Y1 in a stable state.

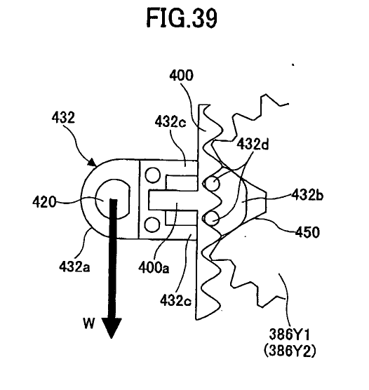

As is shown in the enlarged view of FIG. 39, in a case where the tape cartridge container 401 is lowered along the periphery of the pulley 386Y1, the running speed of the timing belt 400 and the direction of the load W correspond so that a large load W generated from the horizontal movement of the tape cartridge container 401 acts on the belt coupling member 432. However, by engaging the inner protruding section 432b with the concave engaging section 450, the belt coupling member 432 may be stably held even when the load W increases.

Also, when the tape cartridge container 401 passes the pulley 386Y2, the running speed of the timing belt 400 and the direction of the load W act in substantially opposite directions (approximately 180 degrees) with respect to each other so that two opposing forces, namely, the driving force of the timing belt 400 and the load W of the tape cartridge container 401 act on the belt coupling member 432 simultaneously. However, by engaging the inner protruding section 432b with the concave engaging section 450, the belt coupling member 432 may be stably held.

The present application is based on and claims the benefit of the earlier filing date of Japanese Patent Application No. 2005-269194 filed on Sep. 15, 2005, the entire contents of which are hereby incorporated by reference.

While the particular autoloader 100 as herein shown and disclosed in detail is fully capable of obtaining the objects and providing the advantages herein before stated, it is to be understood that it is merely illustrative of various embodiments of the invention. No limitations are intended to the details of construction or design herein shown other than as described in the appended claims.

What is claimed is:

1. A media cartridge autoloader that transfers a media cartridge between a movable media cartridge container and a media drive, the media cartridge autoloader comprising:
a movable belt that is positioned around a pulley, the belt moving the media cartridge container;
a coupling member that couples the media cartridge container to the belt; and
an engaging mechanism that engages the coupling member when the media cartridge is positioned near the pulley.

2. The media cartridge autoloader as claimed in claim 1,
wherein the engaging mechanism is integrally formed as part of the pulley.

3. The media cartridge autoloader as claimed in claim 2,
wherein the engaging mechanism is radially recessed as part of the pulley.

4. The media cartridge autoloader as claimed in claim 3,
wherein the coupling member is configured to move along a periphery of the pulley and includes a protruding part that engages with the engaging mechanism when the coupling part moves along the periphery of the pulley.

5. The media cartridge autoloader as claimed in claim 4,
wherein the coupling member supports a load of the media cartridge container with the engagement between the protruding part and the engaging mechanism while the media cartridge container is raised/lowered through rotation of the pulley.

6. The media cartridge autoloader as claimed in claim 1,
wherein the belt is positioned around two pulleys, each pulley including an engaging mechanism that engages the coupling member when the media cartridge is positioned near the pulley.

7. The media cartridge autoloader as claimed in claim 6,
wherein the belt rotates around the pulleys in a substantially oval configuration.

8. The media cartridge autoloader as claimed in claim 1,
wherein the movable belt simultaneously moves a plurality of media cartridge containers.

9. The media cartridge autoloader as claimed in claim 8,
wherein each of the media cartridge containers is coupled to the belt by a separate coupling member.

10. The media cartridge autoloader as claimed in claim 1,
wherein the pulley includes two substantially similar engaging mechanisms.

11. The media cartridge autoloader as claimed in claim 10,
wherein the two engaging mechanisms are positioned at approximately 180 degrees from one another around a periphery of the pulley.

12. A method of transferring a media cartridge between a movable media cartridge container and a media drive, the method comprising the steps of:
moving the media cartridge container by a movable belt that is positioned around a pulley, the media cartridge container being coupled to the belt by a coupling member; and
engaging the coupling member with an engaging mechanism when the media cartridge is positioned near the pulley.
